(19) United States
(12) Patent Application Publication
(10) Pub. No.: US 2008/0091731 A1
(43) Pub. Date: Apr. 17, 2008

(54) Multi-media file automatic updating method and software program thereof

(75) Inventor: Yi-Hsiu Lee, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/907,147

(22) Filed: Oct. 10, 2007

(30) Foreign Application Priority Data
Oct. 14, 2006 (TW) 095137912

(51) Int. Cl. G06F 17/30

(52) U.S. Cl. 707/104.1; 707/E17.01; 707/E17.009

(57) ABSTRACT

A multi-media file automatic updating method and a software program thereof is disclosed in the present invention. The method includes: through setting the sequence to play a plural of multi-media files, automatically copying a part of the multi-media files to the storage space of a portable device according to the playing sequence; when the portable device connecting to the host, automatically judging the multi-media files stored in the storage space which have been completely played; automatically deleting the multi-media files which have been completely played; and automatically copying a part of the multi-media files following the multi-media files stored in the storage space to the storage space according to the playing sequence, thereby performing the updating between the host and the portable device automatically and orderly according to the sequence of the multi-media files.

### BACKGROUND OF THE INVENTION

1. Field of the Invention

The invention relates to a multi-media file automatic updating method and, more particularly, to a multi-media file automatic updating method and software program used between a host and a portable device.

2. Description of the Related Art

With the downsizing of the electronic devices, the portable devices with music or film playback functions have been widely used, such as a multi-media player, an MP3 player, a mobile phone, a PDA and so on. However, the multi-media contents completely stored in a computer need be transferred to a portable device so that a user can see or listen to the multi-media contents anyplace and anytime, and therefore how to make the multi-media contents updated automatically between the computer and the portable device is needed.

First, please referring to FIG. 1, as shown in FIG. 1, many multi-media files 11, 12, 13, 14, 15, 16, 17, 18 are stored in a hard disk 10 of a computer 1. According to a conventional multi-media contents automatic updating software, in the method of multi-media file automatic updating between the computer 1 and a multi-media player 2, all or several of the multi-media files 11, 12, 13, 14, 15, 16, 17, 18 in the hard disk 10 are manually chose and then copied to a memory 20 of the multi-media player 2, so that all or several of the multi-media files 11, 12, 13, 14, 15, 16, 17, 18 chose manually can be automatically updated into the memory 20 of the multi-media player 2.

Secondly, please referring to FIG. 2, for a portable device 3 with music or film playback functions, such as a multi-media player, an MP3 player, a mobile phone, or a PDA, because of the limit capacity of a memory 30 in the portable device 3, if the contents of the multi-media files 11, 12, 13, 14, 15, 16, 17, 18, which may be an audio-book, language teaching, a lengthy film, need be listened to or saw in order, they may not be stored in the portable device 3 at a time, since the memory 30 as shown in FIG. 2 can only contain a limited number of multi-media files 11, 12, 13, 14.

Therefore, after the multi-media files 11, 12, 13, 14 have been completely played, the user of the portable device 3 need to manually delete the multi-media files 11, 12, 13, 14 completely played, and then manually choose the following multi-media files 15, 16, 17, 18 and copy them to the memory 30 in the portable device 3, so that the following multi-media files 15, 16, 17, 18 can be played continuously. The manual operations of deleting and copying are very inconvenient.

### BRIEF SUMMARY OF THE INVENTION

The objective of the present invention is to provide a multi-media file automatic updating method and program, which can automatically update the multi-media files between the host and the portable device.

The another objective of the present invention is to provide a multi-media file automatic updating method and program, which can automatically update the multi-media files between the host and the portable device according to the playing sequence of the multi-media files.

To achieve the above (or other) objectives, the invention provides a multi-media file automatic updating method, to automatically update the contents stored in the portable device, including the steps of: choosing a plural of multi-media files and setting the playing sequence; automatically copying at least one of the multi-media files to a storage space of the portable device according to the playing sequence; automatically judging whether the multi-media file stored in the storage space has been completely played; automatically deleting the multi-media file stored in the storage space which has been completely played; and automatically copying a part of said multi-media files following the multi-media files stored in the storage space to the storage space according to the playing sequence.

To achieve the above (or other) objectives, the invention provides a storage medium readable to a computer, loaded with a multi-media file automatic updating software program. The multi-media file automatic updating software program is used to update a plural of multi-media files which have a sequence, and it is used in a computer, to automatically update the contents stored in a portable device, wherein the multi-media file automatic updating software program mainly includes: program codes used to choose a plural of multi-media files and set a playing sequence; program codes used to automatically copy a part of the multi-media files to a storage space of the portable device according to the playing sequence; program codes used to automatically judge whether the multi-media files stored in the storage space have been completely played; program codes used to automatically delete the multi-media files stored in the storage space which have been completely played; and program codes used to automatically copy a part of the multi-media files, following the multi-media files already copied to the storage space, to the storage space according to the playing sequence. To achieve the above (or other) objectives, the invention provides a multi-media file playing system, includes: a host, and a portable device. The host includes a storage device, and a control unit, the storage device electrically connected to control unit, the control unit controlling the operation of the storage device, and the storage device storing the multi-media files; the portable device includes a storage space connected to the host by a information-transmission interface; the control unit copies the multi-media files stored in the storage device to the storage space, and generates a device list in the storage device to record the playing sequence of the multi-media files in the portable device.

### BRIEF DESCRIPTION OF THE SEVERAL VIEWS OF THE DRAWINGS

FIG. 1 is a drawing showing a conventional multi-media file automatic updating method.

FIG. 2 is another drawing showing a conventional multi-media file automatic updating method.

FIG. 3A, FIG. 3B, FIG. 3C, FIG. 3D, FIG. 3E are the drawings showing a multi-media file automatic updating method according to a preferred embodiment of the invention.

FIG. 4 is a flowchart showing a multi-media file automatic updating method according to a preferred embodiment of the invention.

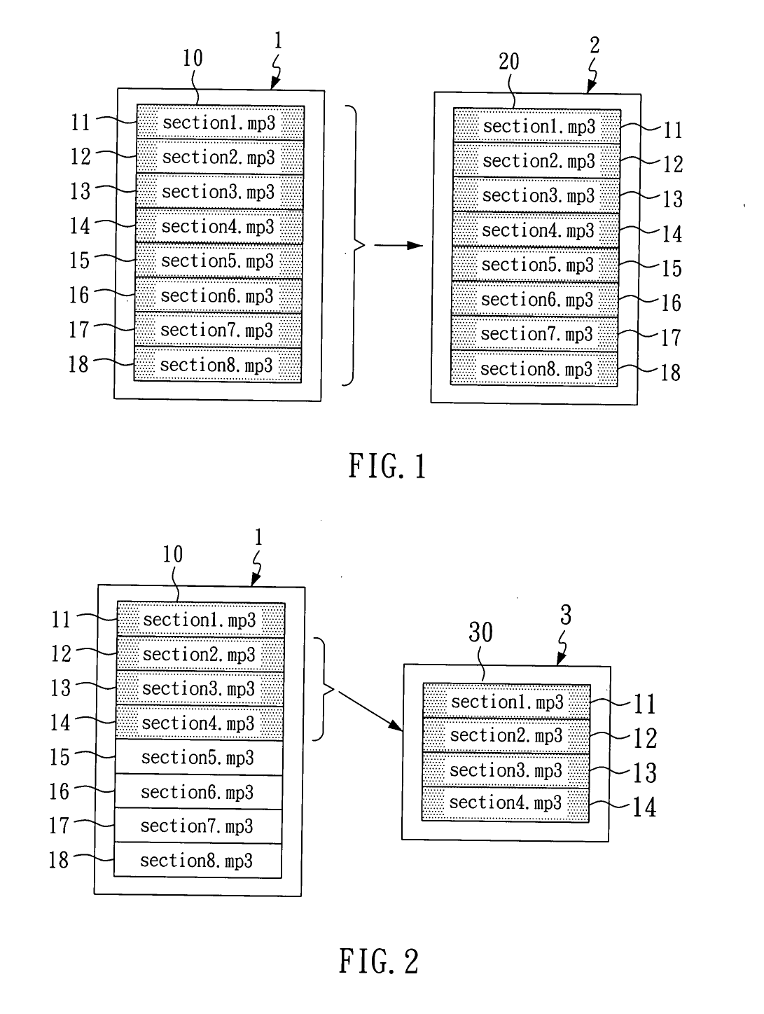

### DETAILED DESCRIPTION OF THE EMBODIMENTS

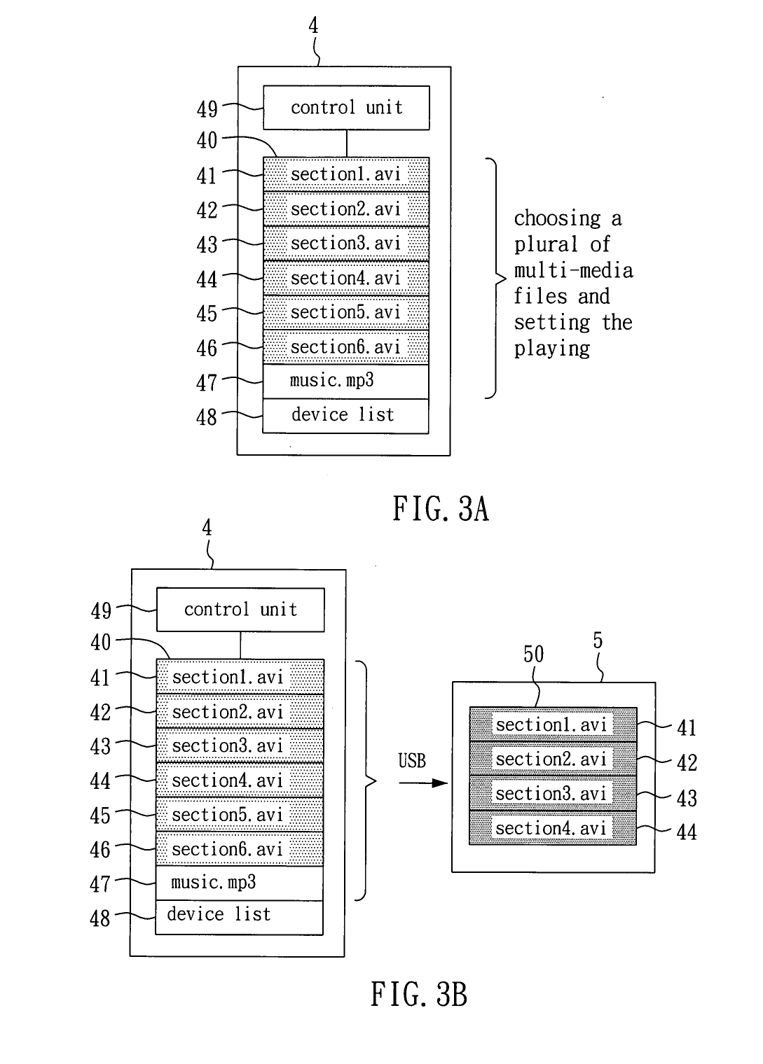

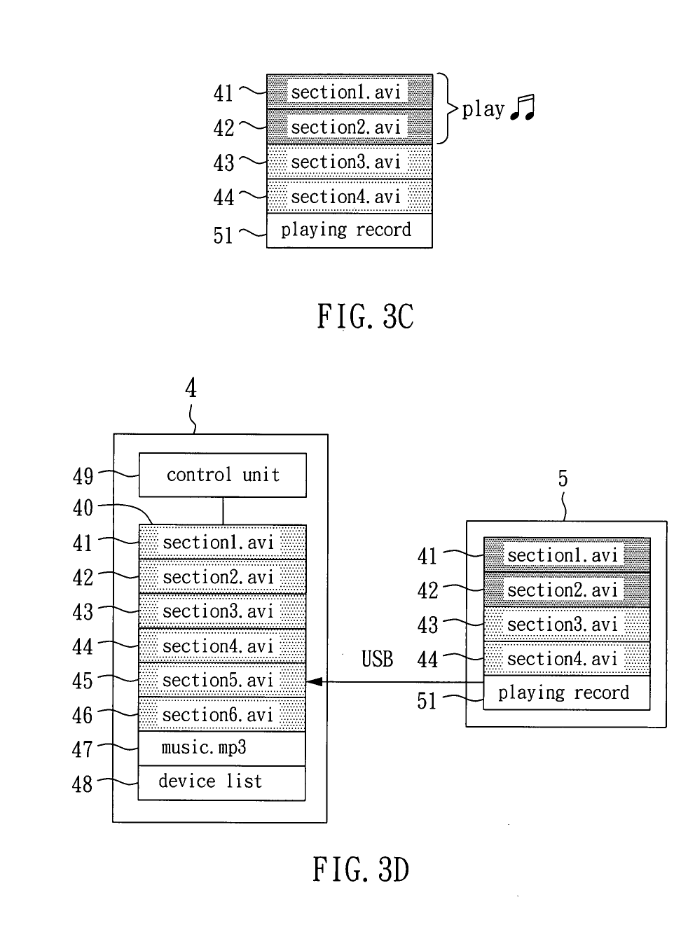

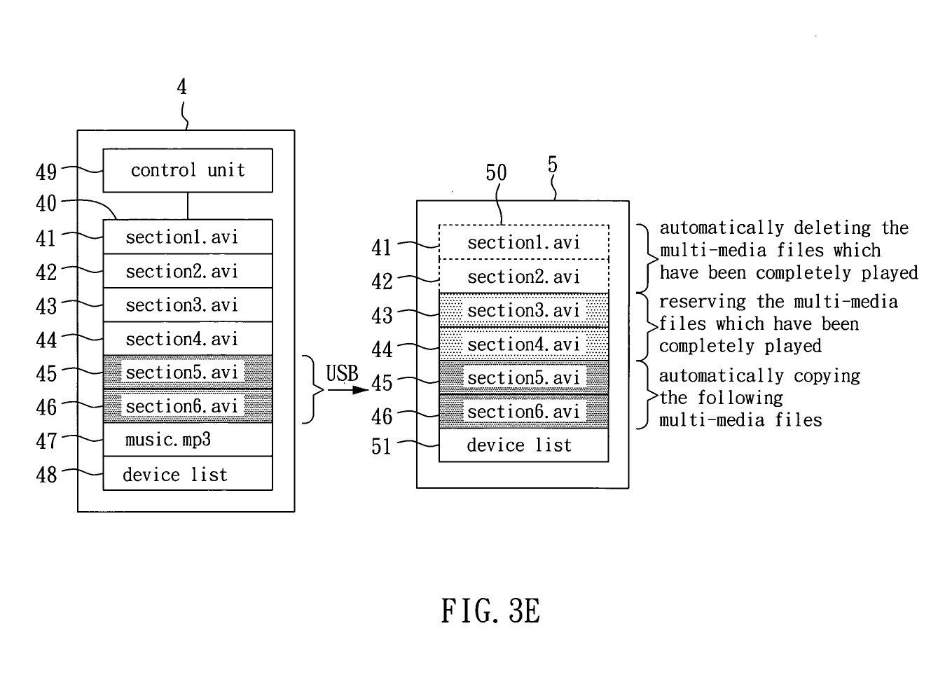

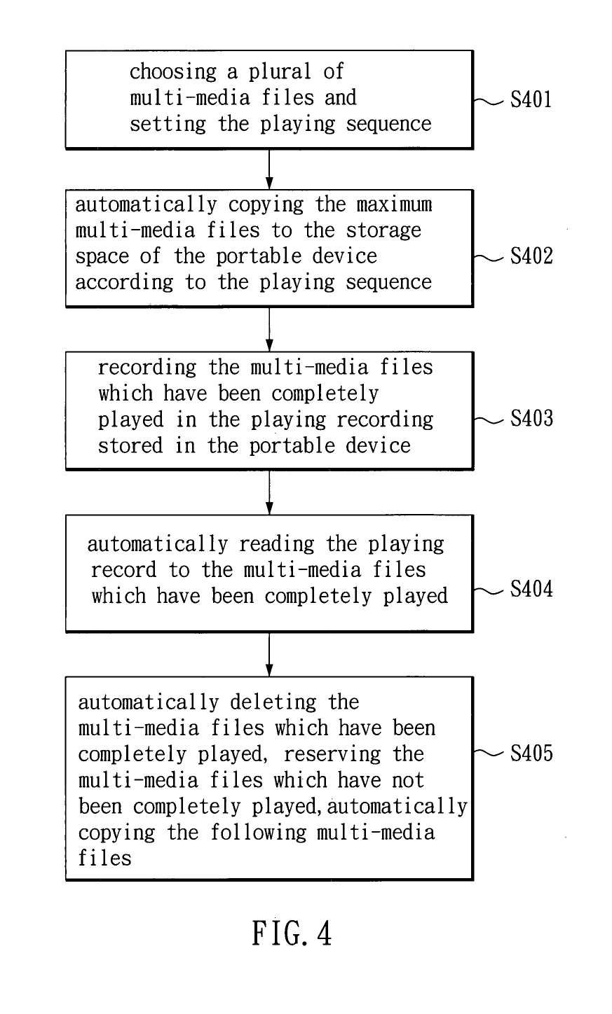

FIG. 3A, FIG. 3B, FIG. 3C, FIG. 3D, FIG. 3E are the drawings showing a multi-media file automatic updating method according to a preferred embodiment of the invention. FIG. 4 is a flowchart showing a multi-media file automatic updating method according to a preferred embodiment of the invention. Referring to FIG. 3A, FIG. 3B, FIG. 3C, FIG. 3D, FIG. 3E and FIG. 4, the host 4 includes a storage device 40 and a control unit 49, and the storage device 40 is electrically connected to the control unit 49. On the other hand, the portable device 5 includes a storage space 50. In this embodiment, the host 4 is connected to the portable device 5 by an information-transmission interface and automatically update by it, as in the drawings, it is a Universal Serial Bus (USB) interface, but in other embodiments, the host 4 and the portable device 5 can be connected by a IEEE 1394 interface and automatically update by it.

There are sever multi-media files 41, 42, 43, 44, 45, 46, 47 stored in the storage device 40 of the host 4, the control unit 49 controls the operation of the storage device 40, and carries out a multi-media file automatic updating software program, the multi-media file automatic updating software program is used to automatically update a plural of multi-media files. In this embodiment, the host 4 is a computer or a server, the storage device 40 is a hard disk, a optical disk drive, or a magnetic tape drive, the control unit 49 is a Central Processing Unit (CPU), and the storage space 50 is a nonvolatile memory, for example: a flash memory, a Electrically Erasable Programmable Read Only Memory (EEPROM), or a Ferroelectric RAM (FRAM).

Referring to FIG. 4, the process of the multi-media file automatic updating software program to automatically update a plural multi-media files is: firstly, referring to FIG. 3A, choosing a series of multi-media files 41, 42, 43, 44, 45, 46 in the multi-media file automatic updating software program, and setting a playing sequence of these multi-media files 41, 42, 43, 44, 45, 46, these multi-media files 41, 42, 43, 44, 45, 46 need to be automatically updated to the storage space 50 of the portable device 5 (step S401). Then the multi-media file automatic updating software program generates a device list 48 to record the playing sequence of the multi-media files 41, 42, 43, 44, 45, 46 and the portable device 5 which need to be automatically updated, wherein the device list includes the identifying code of the portable device 5, the file names of the multi-media files 41, 42, 43, 44, 45, 46, and a series of sequence numbers corresponding to the multi-media files 41, 42, 43, 44, 45, 46.

Secondly, referring to FIG. 3B, the multi-media file automatic updating software program is automatically copying the maximum multi-media files 41, 42, 43, 44, 45, 46 to the storage space 50 of the portable device 5 according to the playing sequence within the capacity of the storage space 50 (step S402). FIG. 3B showing the storage space 50 can only store the multi-media files 41, 42, 43, 44, therefore only copying the multi-media files 41, 42, 43, 44 to the storage space 50. In this embodiment, the capacity of the storage space 50 in the portable device 5, in which stored the multi-media files 41, 42, 43, 44, 45, 46, is the whole capacity of the storage space 50, and in other embodiments, the multi-media file automatic updating software program can set the capacity of the storage space 50 in the portable device 5 stored the multi-media files 41, 42, 43, 44, 45, 46.

Then please referring to FIG. 3C, it generates a playing record 51 in the storage space 50 of the portable device 5, to record the multi-media files 41, 42, 43, 44 which have been completely played when one of the multi-media files 41, 42, 43, 44 which has been completely played (step S403), one of the ways is recording the file names and complete playing time of the multi-media files 41, 42, 43, 44 in the playing record 51, or using a series of playing status tags corresponding to the multi-media files 41, 42, 43, 44 to record the playing status of the multi-media files 41, 42, 43, 44. In other embodiments, the playing sequence of the multi-media files 41, 42, 43, 44, 45, 46 stored in the device list 48 can also be stored in the playing record 51.

Therefore, please referring to FIG. 3D, when a user connects the portable device 5 to the host 4, the multi-media file automatic updating software program automatically reads the playing record 51 stored in the storage space 50 of the portable device 5 to find out which of the multi-media files 41, 42, 43, 44, stored in the storage space 50, have been completely played (step S404).

Then please referring to FIG. 3E, the multi-media file automatic updating software program automatically judges which of the multi-media files 41, 42, 43, 44 have been completely played according to the playing record 51. The playing record 51 records the file names and/or the complete playing time of the multi-media files 41, 42, 43, 44 which have been completely played, or the playing status tags showing which of the multi-media files 41, 42, 43, 44 have been completely played, for example: the multi-media files 41, 42. After that, the multi-media file automatic updating software program automatically deletes the multi-media files 41, 42 stored in the storage space 50, and reserves the multi-media files 43, 44 which have not been completely played, and automatically copies the multi-media files 45, 46, following the multi-media files already copied to the storage space 50, to the storage space 50 according to the playing sequence (step S405), the multi-media file automatic updating software program automatically copies the maximum multi-media files 45, 46 to the storage space 50 of the portable device 5 according to the playing sequence within the remain capacity of the storage space 50. Therefore the multi-media files 41, 42, 43, 44, 45, 46 are automatically updated between the host 4 and the portable device 5 according to the playing sequence.

Therefore, as described above, the embodiment of the invention is setting a playing sequence of the multi-media files by a multi-media file automatic updating software program in the host, automatically copying the multi-media files to the storage space of the portable device according to the playing sequence, and when the portable device is connected to the host, automatically judging whether the multi-media files stored in the storage space have been completely played, automatically deleting the multi-media files which have been completely played, and automatically copying a part of the multi-media files, following the multi-media files already copied to the storage space, to the storage space according to the playing sequence, to automatically update the multi-media files between the host and the portable device according to the playing sequence of the multi-media files.

And the steps of the embodiment of the invention can be written and carried out by the computer language. The software program can be stored in a record medium, which readable to a microprocessor unit, or the device having a record medium. There is no limit to it, the record medium can be a hard disk, a flexible disc, an optical disk, a ZIP Magneto-Optical Disk, an IC chip, a Random Access Memory, or any device includes the record medium which can be used by the persons having ordinary skill in the art. As the multi-media file automatic updating method according to the invention has already been disclosed above, persons with the ability of writing computer language can know how to write the software program after reading the specification, therefore the part of writing the software program will not be described here.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A multi-media file automatic updating method, to automatically update the contents stored in a portable device, comprising the steps of:
setting the sequence to play a plural of multi-media files;
copying at least one of said multi-media files to a storage space of said portable device according to said playing sequence;
judging whether said multi-media file stored in said storage space has been completely played;
deleting said multi-media file stored in said storage space which has been completely played; and
copying at least next one of said multi-media files, which has not been copied to said storage space, to said storage space according to said playing sequence.

2. The multi-media file automatic updating method according to claim 1, wherein said setting step is generating a device list to set the sequence to play a plural of multi-media files.

3. The multi-media file automatic updating method according to claim 2, wherein said device list includes the identifying code of said portable device, the file names of said multi-media files, or a series of sequence numbers corresponding to said multi-media files.

4. The multi-media file automatic updating method according to claim 1, wherein said setting step is choosing a plural of multi-media files to set the playing sequence of said multi-media files.

5. The multi-media file automatic updating method according to claim 1, wherein said judging step is automatically reading a playing record stored in said portable device to automatically judge whether said multi-media files stored in said storage space have been completely played.

6. The multi-media file automatic updating method according to claim 5, wherein said playing record includes the identifying code of said portable device, the file names of said multi-media files, or a series of sequence numbers corresponding to said multi-media files.

7. The multi-media file automatic updating method according to claim 5, wherein said playing record includes the file names of said multi-media files which have been completely played, or the complete playing time.

8. The multi-media file automatic updating method according to claim 5, wherein said playing record includes a series of playing status tags corresponding to said multi-media files to record the playing status of said multi-media files, and said deleting step is automatically deleting said multi-media files whose playing status tags show that said multi-media files have been completely played.

9. The multi-media file automatic updating method according to claim 1, wherein the capacity of said storage space can be set.

10. The multi-media file automatic updating method according to claim 1, wherein said storage space is a flash memory.

11. The multi-media file automatic updating method according to claim 1, wherein, automatically copying said multi-media files to said storage space according to said playing sequence is automatically copying the maximum multi-media files to said storage space according to said playing sequence within the capacity of said storage space.

12. The multi-media file automatic updating method according to claim 1, wherein said steps are carried out through a Universal Serial Bus interface.

13. A storage mediums readable to a computer, loaded with a multi-media file automatic updating software program which is used to update a plural of multi-media files with a sequence, and is used in a computer, to automatically update the contents stored in a portable device, wherein said multi-media file automatic updating software program mainly comprises:
program codes for setting a playing sequence of a plural of multi-media files;
program codes for copying at least one of said multi-media files to a storage space of said portable device according to said playing sequence;
program codes for judging whether said multi-media files stored in said storage space have been completely played;
program codes for deleting said multi-media files stored in said storage space which have been completely played; and
program codes for copying at least next one of said multi-media files, following said multi-media files already copied to said storage space, to said storage space according to said playing sequence.

14. The storage medium readable to a computer according to claim 13, wherein said program further comprises:
program codes for setting the capacity of said storage space.

15. A multi-media file playing system, comprising:
a host including a storage device and a control unit, said storage device electrically connected to said control unit, said control unit controlling the operation of said storage device, and said storage device storing with a plural of multi-media files; and
a portable device including a storage space connected to said host by a information-transmission interface;
wherein said control unit copies a plural of multi-media files stored in said storage device to said storage space, and generates a device list in said storage device to record the playing sequence of said multi-media files in said portable device.

16. The multi-media file playing system according to claim 15, wherein said device list includes the identifying code of said portable device, the file names of said multi-media files, or a series of sequence numbers corresponding to said multi-media files.

17. The multi-media file playing system according to claim 15, wherein said control unit further generates a playing record in said portable device to record whether said multi-media files stored in said storage space have been completely played.

18. The multi-media file playing system according to claim 15, wherein said playing record includes the identifying code of said portable device, the file names of said multi-media files, or a series of sequence numbers corresponding to said multi-media files.

19. The multi-media file playing system according to claim 15, wherein said playing record includes the file names of said multi-media files which have been completely played, or the complete playing time.

20. The multi-media file playing system according to claim 15, wherein said information-transmission interface is a Universal Serial Bus interface.
